(19) United States
(12) Patent Application Publication
(10) Pub. No.: US 2017/0026909 A1
(43) Pub. Date: Jan. 26, 2017

(54) SELECTIVE TILE DOWNLOAD USING A CACHE OF TRANSMITTER PARAMETERS

(71) Applicant: QUALCOMM Incorporated, San Diego, CA (US)

(72) Inventors: Weihua Gao, San Jose, CA (US); Gengsheng Zhang, Cupertino, CA (US); Sundar Raman, Fremont, CA (US)

(21) Appl. No.: 14/809,007

(22) Filed: Jul. 24, 2015

(51) Int. Cl. H04W 52/02; H04B 17/27; H04W 4/02

(52) U.S. Cl. CPC H04W 52/0229; H04W 4/023; H04B 17/27

(57) ABSTRACT

Example methods, apparatuses, or articles of manufacture are disclosed herein that may be utilized, in whole or in part, to facilitate or support one or more operations or techniques for selective downloading of one or more positioning tiles using a cache of transmitter parameters, such as for use in or with a mobile communication device, for example.

### BACKGROUND

1. Field

The present disclosure relates generally to position or location estimations of mobile communication devices and, more particularly, to selective tile download using a cache of transmitter parameters for use in or with mobile communication devices.

2. Information

Mobile communication devices, such as, for example, cellular telephones, portable navigation units, laptop computers, personal digital assistants, or the like are becoming more common every day. Certain mobile communication devices, such as, for example, location-aware cellular telephones, smart telephones, or the like may assist users in estimating their geographic locations by providing positioning assistance parameters obtained or gathered from various systems. For example, in an outdoor environment, certain mobile communication devices may obtain an estimate of their geographic location or so-called “position fix” by acquiring wireless signals from a satellite positioning system (SPS), such as the global positioning system (GPS) or other like Global Navigation Satellite Systems (GNSS), cellular base station, etc. via a cellular telephone or other wireless communications network. Acquired wireless signals may, for example, be processed by or at a mobile communication device, and its location may be estimated using known techniques, such as Advanced Forward Link Trilateration (AFLT), base station identification, cell tower triangulation, or the like.

In an indoor environment, mobile communication devices may be unable to reliably receive or acquire satellite or like wireless signals to facilitate or support one or more position estimation techniques. For example, signals from an SPS or other wireless transmitters may be attenuated or otherwise affected in some manner (e.g., insufficient, weak, fragmentary, etc.), which may at least partially preclude their use for position estimations. At times, a mobile communication device may obtain a position fix by measuring ranges to three or more terrestrial wireless access points positioned at known locations. Ranges may be measured, for example, by obtaining a Media Access Control identifier (MAC ID) address from wireless signals received from suitable access points and measuring one or more characteristics of received signals, such as signal strength, round trip delay, or the like. In some instances, a position of a mobile communication device may also be estimated via radio heat map signature matching. For example, current or live characteristics of wireless signals received at a mobile communication device may be compared with expected or previously measured signal characteristics stored as heat map values in a database. By finding a signature in a database that more closely matches characteristics exhibited by signals currently received at a mobile communication device, a location associated with a matching signature may be used as an estimated location of the device.

At times, a position of a mobile communication device may, for example, be estimated in connection with one or more positioning tiles. For example, a number of wireless transmitters, indoor or otherwise, may be grouped into a geographically-bounded area (e.g., 1.0 km by 1.0 km square, etc.) to comprise and/or be defined via a so-called “positioning tile” or simply “tile.” A tile may include positioning assistance parameters, such as locations, identities, characteristics, etc. for one or more known wireless transmitters, for example, representative of and/or corresponding to a particular geographic area. As such, a mobile communication device may retrieve (e.g., access, download via a server, etc.) and/or use one or more tiles to estimate its location within an area using one or more known techniques, such as, for example, techniques mentioned above (e.g., triangulation, radio heat map signature matching, range measurement, etc.).

In some instances, however, such as if a mobile communication device travels rapidly (e.g., on a highway via a route covered by multiple tiles of positioning assistance parameters, etc.), for example, it may need to download or use several tiles to maintain adequate positioning performance. At times, more frequent tile downloads may significantly tax available resources, such as bandwidth in wireless communication links, for example. This may also affect memory of a mobile communication device, especially if only a smaller portion of downloaded parameters (e.g., locations, identities, etc. of wireless transmitters proximate to a traveled route, etc.) is needed or useful for positioning. More frequent tile downloads may also increase power consumption of certain mobile communication devices, such as mobile devices with limited power resources (e.g., battery-operated, etc.), for example, thus, affecting operating lifetime or overall utility of such devices.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating features associated with an implementation of an example operating environment.

FIG. 2 is a flow diagram illustrating an implementation of an example process that may be performed to facilitate or support selective tile download using a cache of transmitter parameters.

FIG. 3 is a flow diagram of an implementation of a process illustrating an example use case of selective tile download using a cache of transmitter parameters.

FIG. 4 is a schematic diagram illustrating an implementation of an example computing environment associated with a mobile device.

FIG. 5 is a schematic diagram illustrating an implementation of an example computing environment associated with a server.

### SUMMARY

Example implementations relate to techniques for selective tile download using a cache of transmitter parameters. In one implementation, a method may comprise maintaining, at a mobile device, a cache of parameters descriptive of attributes of a set of transmitters, the attributes indicating at least locations and identities of the set of transmitters; attempting to match an acquired wireless signal with the identities of the set of transmitters sufficient to perform the positioning operation; and selectively downloading a tile of positioning assistance parameters descriptive of attributes of one or more additional transmitters based, at least in part, on an absence of a match of the acquired wireless signal with the identities of the set of transmitters sufficient to perform the positioning operation.

In another implementation, an apparatus may comprise means for maintaining, at a mobile device, a cache of parameters descriptive of attributes of a set of transmitters, the attributes indicating at least locations and identities of the set of transmitters; means for attempting to match an acquired wireless signal with the identities of the set of transmitters sufficient to perform the positioning operation; and means for selectively downloading a tile of positioning assistance parameters descriptive of attributes of one or more additional transmitters based, at least in part, on an absence of a match of the acquired wireless signal with the identities of the set of transmitters sufficient to perform the positioning operation.

In yet another implementation, an apparatus may comprise a mobile device comprising a wireless transceiver to communicate with an electronic communications network; and one or more processors coupled to a memory to maintain a cache of parameters descriptive of attributes of a set of transmitters, the attributes to indicate at least locations and identities of the set of transmitters; attempt to match an acquired wireless signal with the identities of the set of transmitters sufficient to perform the positioning operation; and selectively download, via the electronic communications network, a tile of positioning assistance parameters descriptive of attributes of one or more additional transmitters based, at least in part, on an absence of a match of the acquired wireless signal with the identities of the set of transmitters sufficient to perform the positioning operation.

In yet another implementation, a method may maintaining, at a server device, a cache of parameters descriptive of attributes of a set of transmitters for an area, the attributes indicating at least locations and identities of the set of transmitters; attempting, in response to a message from a mobile device, to match the identities of the set of transmitters sufficient to perform the positioning operation with parameters descriptive of attributes of one or more additional transmitters within the area received via the message; and estimating a location of the mobile device based, at least in part, on a match of the identities of the set of transmitters sufficient to perform the positioning operation with the parameters descriptive of the attributes of the one or more additional transmitters within the area. It should be understood, however, that these are merely example implementations, and that claimed subject matter is not limited to these particular implementations.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be implemented, in whole or in part, to facilitate or support one or more operations and/or techniques for selective downloading of one or more positioning tiles using a cache of transmitter parameters for use in or with mobile communication devices. As used herein, “mobile device,” “mobile communication device,” “location-aware mobile device,” or like terms may be used interchangeably and may refer to any kind of special purpose computing platform or apparatus that may from time to time have a position or location that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be called simply mobile devices, may include, for example, cellular telephones, smart telephones, personal digital assistants (PDAs), laptop computers, personal entertainment systems, tablet personal computers (PC), personal audio or video devices, personal navigation devices, radio heat map generation tools, or the like. It should be appreciated, however, that these are merely examples of mobile devices that may be used, at least in part, to implement one or more operations and/or techniques for selective downloading of one or more positioning tiles using a cache of transmitter parameters, and that claimed subject matter is not limited in this regard. It should also be noted that the terms “position” and “location” may be used interchangeably herein.

As was indicated, at times, a position fix of a mobile device may, for example, be obtained based, at least in part, on positioning assistance parameters that may be selectively provided to the mobile device, such as by a navigation system, location server, or the like. In some instances, positioning assistance parameters may comprise, for example, one or more parameters descriptive of attributes of wireless transmitters (e.g., Wi-Fi access points, cellular base stations, Bluetooth devices, Near Field Communication (NFC) devices, etc.) positioned at known locations. These attributes may include, for example, MAC addresses, cellular identification numbers (Cell IDs), transmission power levels, characteristics of wireless signals, etc., just to provide a few examples. With the knowledge of one or more attributes of wireless transmitters, a mobile device may then estimate its location, such as using one or more appropriate techniques, as was also indicated. One technique for obtaining positioning assistance parameters for a mobile device may include, for example, accessing the parameters via a remote server (e.g., location server, positioning assistance server, etc.), such as through a selection of a Uniform Resource Locator (URL). In addition, at times, positioning assistance parameters may comprise, for example, electronic digital map-related parameters (e.g., for additional context, etc.), radio heat map values (e.g., to assist in localization, etc.), or the like, such as for an area of interest, indoor or otherwise. Of course, these are merely examples of positioning assistance parameters, and claimed subject matter is not so limited.

As was also indicated, in some instances, a mobile device may obtain positioning assistance parameters defined in and/or characterized via one or more so-called “positioning tiles.” As used herein, the terms “positioning tile” or “tile” may be used interchangeably and refer to one or more parameters descriptive of attributes of wireless transmitters grouped with respect to one or more predefined geographically-bounded areas (e.g., 1.0 km by 1.0 km squares, etc.). Such attributes may include, for example, locations, transmission power, unique identifiers (e.g., Wi-Fi MAC address, Cell ID, Bluetooth device ID, Near Field Communication (NFC) device ID, etc.), etc. of wireless transmitters, such as located within and/or proximate to a particular geographically-bounded area. In operative use, a mobile device may, for example, perform a “scan” (e.g., an active scan, passive scan, etc.) to acquire signals transmitted by proximate or “visible” wireless transmitters and/or detect particular parameters encoded in the acquired signals (e.g., unique identifiers, etc.). As a way of illustration, an active scan may, for example, be performed via transmitting one or more requests, such as in the form of one or more unicast packets and receiving one or more responses, and a passive scan may, for example, be performed by “listening” for wireless signals broadcasted by proximate wireless transmitters. One or more detected parameters may, for example, be transmitted to a suitable server, such as a location server, positioning assistance server, etc. in an appropriate message. In response, a server may, for example, transmit a message to a mobile device so as to indicate a set of tiles that may be used, at least in part, for positioning in an area of interest, and, in some instances, may recommend that the mobile device select one specific tile of the set that may be particularly effective and/or useful given unique identifiers obtained via a scan. A mobile device may then select to download one or more tiles from a server, for example, and/or may locally store downloaded tiles for use in one or more positioning operations. At times, a mobile device may transmit one or more detected parameters to a server along with a request to compute a position fix, such as without requesting and/or downloading a tile, for example. It should be noted that “wireless transmitters” and “transmitters” may be used interchangeably herein, and may be capable of transmitting and/or receiving wireless signals, depending on an implementation.

As alluded to previously, at times, downloading multiple tiles of positioning assistance parameters may, for example, tax available network bandwidth, associated computational resources, lead to increased processing times, affect power consumption of a mobile device, or the like. For example, in some instances, such as if a mobile device travels rapidly (e.g., a user of a co-located mobile device is driving a car, etc.), it may be needed or useful to download several tiles to maintain adequate positioning performance. At times, however, due, at least in part, to its limited memory capacity, coverage or metadata transfer plan, etc., a mobile device may be unable to reliably receive and/or download, for example, a plurality of tiles covering one or more areas of interest into a local memory. Thus, resources at a mobile device may not be capable of processing, for example, associated positioning assistance parameters in a more efficient or effective manner to perform location determination. As such, in some instances, positioning or navigation capabilities of certain mobile devices may be less useful or possibly faulty. In addition, typical Wi-Fi tile downloads (e.g., General Packet Radio Service Tunneling Protocol (GTP)-Wi-Fi, etc.) may not differentiate, for example, between a moving and a stationary mobile device, meaning that the same volume of parameters may be downloaded to the device irrespective of a co-located user's mobility and/or usage patterns. Downloading several tiles to only use a portion of associated positioning assistance parameters, for example, may also present challenges, as mentioned above. Accordingly, it may be desirable to develop one or more methods, systems, or apparatuses that may enable or otherwise improve mobile device location and/or navigation services, such as in connection with one or more positioning tiling techniques, for example.

Thus, as will be described in greater detail below, in an implementation, to improve and/or optimize tile downloads and/or positioning assistance parameters usage, one or more parameters descriptive of attributes of a set of transmitters, such as one or more wireless (e.g., Wi-Fi, etc.) transmitters may be maintained in some manner, such as in a memory cache of a mobile device, for example. A “memory cache” or simply “cache” refers to a component and/or function capable of storing parameters (e.g., as one or more digital signals, etc.) to facilitate or support faster accessing to and/or serving of such parameters, such as in relation to parameters stored in a main memory, for example. Depending on an implementation, a cache may comprise, for example, a reserved section of a main memory, independent storage location that may or may not be external to a main memory, or any combination thereof. A cache may, for example, have capacity and/or capability to store parameters descriptive of attributes of a limited or finite number of wireless transmitters, which may also depend on a particular implementation, application, tiling technique, or the like. Memory caches are generally known and need not be described here in greater detail.

As will be seen, in at least one implementation, one or more parameters descriptive of attributes of wireless transmitters may be maintained in some manner in a cache of a mobile device, such as, for example, via locating, storing, and/or replacing wireless transmitters sufficient to perform a positioning operation within a particular area of interest, indoor or otherwise. Here, to facilitate or support maintaining a cache of parameters, a set cover-type approach, a wireless transmitter ranking-type approach, or any combination thereof may, for example, be employed, at least in part, as also discussed below in greater detail. As used herein, “wireless transmitters sufficient to perform a positioning operation” refer to one or more transmitters (e.g., a set, etc.) having parameters (locations, identities, etc.) enabling a mobile device to obtain a position fix autonomously or independently, such as without accessing a remote server and/or downloading a positioning tile. A mobile device may, for example, obtain a position fix using any suitable positioning technique, such as triangulation, trilateration, radio heat map signature matching, proximity, or the like.

As will also be seen, in some instances, one or more unique identifiers, such as obtained via a scan discussed above, for example, may be matched with unique identifiers stored in a mobile device's cache and descriptive of wireless transmitters more frequently used for obtaining a position fix within a particular area. If sufficient matches to enable a successful positioning operation within that area are found, for example, a mobile device may not download a tile. If sufficient matches to enable a successful positioning operation within the area are not found, however, a mobile device may forward obtained unique identifiers to a server to download a tile. From time to time, one or more parameters in a cache may, for example, be replaced with parameters for different transmitters that may, over time, prove to be more effective or useful at enabling a mobile device to successfully perform a positioning operation than parameters that are being replaced. Parameters descriptive of attributes of wireless transmitters may, for example, be stored in a cache in the form of any suitable structure or construct, such as a list, table, matrix, etc., just to name a few examples.

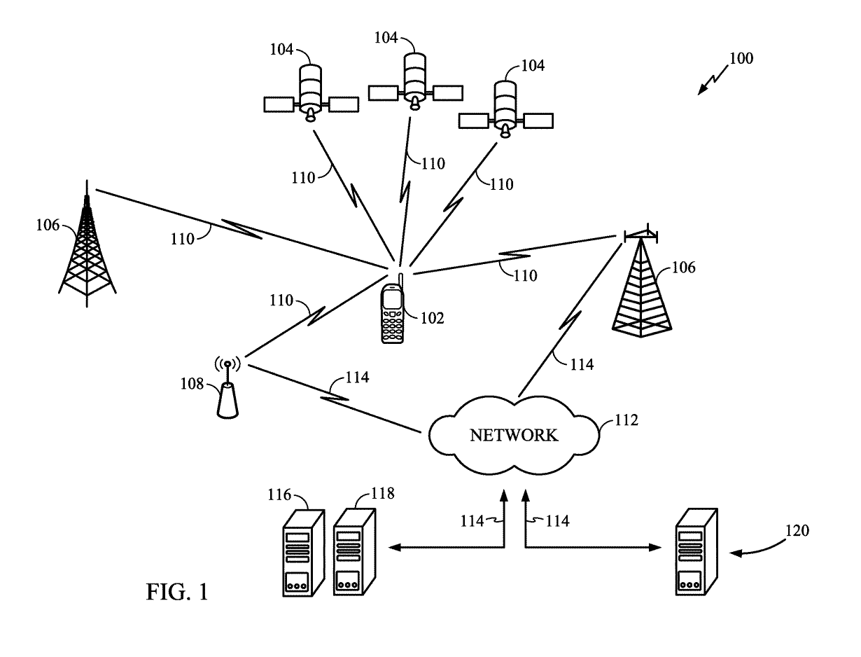

FIG. 1 is a schematic diagram illustrating features associated with an implementation of an example operating environment 100 capable of facilitating or supporting one or more processes or operations for selective downloading of one or more positioning tiles using a cache of transmitter parameters, such as for use in or with a mobile device 102, for example. It should be appreciated that operating environment 100 is described herein as a non-limiting example that may be implemented, in whole or in part, in the context of various communications networks or combination of networks, such as public networks (e.g., the Internet, the World Wide Web), private networks (e.g., intranets), wireless local area networks (WLAN, etc.), or the like. It should also be noted that claimed subject matter is not limited to indoor implementations. For example, at times, one or more operations or techniques described herein may be performed, at least in part, in an indoor-like environment, which may include partially or substantially enclosed areas, such as urban canyons, town squares, amphitheaters, parking garages, rooftop gardens, patios, or the like. At times, one or more operations or techniques described herein may be performed, at least in part, in an outdoor environment.

As illustrated, operating environment 100 may comprise, for example, one or more satellites 104, base transceiver stations 106, wireless transmitters 108, etc. capable of communicating with mobile device 102 via wireless communication links 110 in accordance with one or more communication protocols. Satellites 104 may be associated with one or more satellite positioning systems (SPS), such as, for example, the United States Global Positioning System (GPS), the Russian GLONASS system, the European Galileo system, as well as any system that may utilize satellites from a combination of satellite systems, or any satellite system developed in the future. Base transceiver stations 106, wireless transmitters 108, etc. may be of the same or similar type, for example, or may represent different types of devices, such as access points, radio beacons, cellular base stations, femtocells, or the like, depending on an implementation. At times, one or more wireless transmitters, such as wireless transmitters 108, for example, may be capable of transmitting as well as receiving wireless signals. Although not shown, in some instances, operating environment 100 may, for example, include a relatively larger number of wireless transmitters 108 associated with an indoor or like area of interest.

In some instances, one or more base transceiver stations 106, wireless transmitters 108, etc. may, for example, be operatively coupled to a network 112 that may comprise one or more wired or wireless communications or computing networks capable of providing suitable information, such as via one or more wireless communication links 114, 110, etc. As will be seen, information may include, for example, positioning assistance parameters, such as locations, identities, etc. of one or more base transceiver stations 106, wireless transmitters 108, etc., a radio heat map, positioning tile, recent position fix obtained via an SPS, or the like. As a way of illustration, positioning assistance parameters may, for example, be provided in the form of a list, digital map, look-up table, mathematical formula, suitable model, algorithm, heat map metadata, etc., which may depend, at least in part, on an application, network, environment, or the like. In an implementation, network 112 may be capable of facilitating or supporting communications between suitable computing platforms or devices, such as, for example, mobile device 102, one or more base transceiver stations 106, wireless transmitters 108, as well as one or more servers associated with operating environment 100. In some instances, servers may include, for example, a location server 116, positioning assistance server 118, as well as one or more other servers, indicated generally at 120 (e.g., navigation, information, map, etc. server, etc.), capable of facilitating or supporting one or more operations or processes associated with operating environment 100.

Location server 116 may provide a coarse location of mobile device 102 with operating environment 100. In addition, at times, location server 116 may, for example, provide a location context identifier (LCI) for a particular area of interest. An LCI may comprise or be associated with a locally defined area, such as a particular floor of a building or other indoor or like area of interest that is not mapped according to a global coordinate system (e.g., mapped according to a local coordinate system, etc.), just to illustrate one possible implementation. Thus, in some instances, mobile device 102 may communicate a request to location server 116 to provide one or more LCIs covering an area of interest or adjacent areas, if applicable. Here, a request may reference or otherwise include, for example, a coarse location of mobile device 102, as was indicated, such that location server 116 may associate the coarse location of mobile device 102 with an area covered by one or more LCIs, and then communicate relevant LCIs to mobile device 102. In some instances, mobile device 102 may utilize one or more received LCIs, in whole or in part, in subsequent messages with a suitable server, such as server 120, for example, to obtain navigation, map, or other information relevant to an area identified by one or more LCIs (e.g., a digital map, routeability graph, etc.).

Positioning assistance server 118 may, for example, provide positioning assistance parameters, such as identities, locations, etc. of relevant wireless transmitters, a radio heat map covering an area of one or more LCIs, though claimed subject matter is not so limited. For example, in some instances, positioning assistance parameters may comprise a positioning tile that may be used, at least in part, to compute a position fix of mobile device 102 in an area of interest.

Server 120 may comprise a map server, for example, that may provide an electronic digital map (e.g., for additional context, etc.) as well as other positioning assistance parameters or like information for a particular area of interest. An electronic digital map may comprise, for example, a floor plan, street layout, etc. of an area or portion thereof and may indicate locations of one or more wireless transmitters 108, base transceiver stations 106, etc. relative to mobile device 102, one or more areas within operating environment 100, or the like.

Even though a certain number of computing platforms or devices are illustrated herein, any number of suitable computing platforms or devices may be implemented to facilitate or otherwise support one or more techniques or processes associated with operating environment 100. For example, at times, network 112 may be coupled to one or more wired or wireless communications networks (e.g., Wi-Fi, etc.) so as to enhance a coverage area for communications with mobile device 102, one or more base transceiver stations 106, wireless transmitters 108, servers 116, 118, 120, or the like. In some instances, network 112 may facilitate or support femtocell-based operative regions of coverage, for example. Again, these are merely example implementations, and claimed subject matter is not limited in this regard.

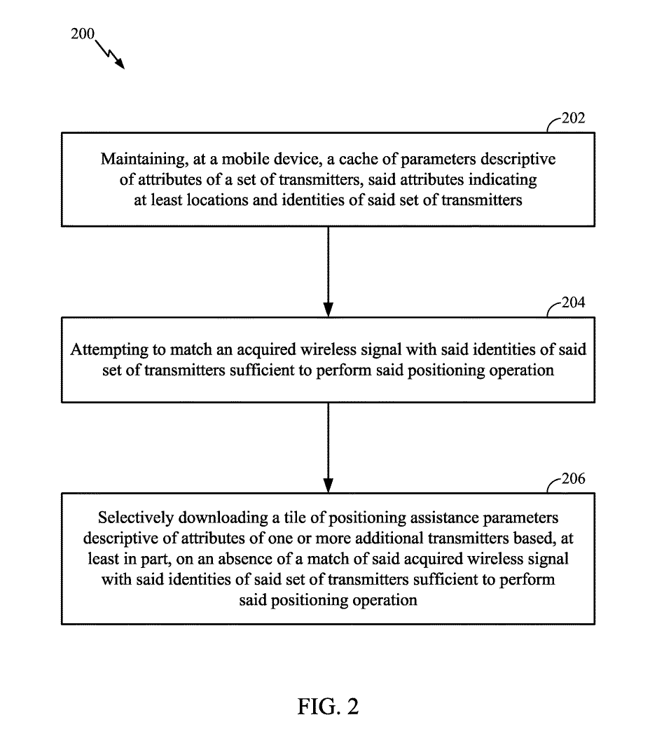

With this in mind, attention is now drawn to FIG. 2, which is a flow diagram illustrating an implementation of an example process 200 that may be performed, in whole or in part, to facilitate or support one or more operations or techniques for selective downloading of one or more positioning tiles using a cache of transmitter parameters. As was indicated, at times, process 200 may be implemented, at least in part, via a location-aware mobile device, such as, for example, mobile device 102 of FIG. 1, though claimed subject matter is not so limited. For example, in some instances, one or more operations of process 200 may be implemented, at least in part, via a server device, such as one or more servers 116, 118, and/or 120 of FIG. 1. It should be noted that information acquired or produced, such as, for example, input signals, output signals, operations, results, etc. associated with example process 200 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

Example process 200 may, for example, begin at operation 202 with maintaining, at a mobile device, a cache of parameters descriptive of attributes of a set of transmitters, the attributes indicating at least locations and identities of the set of transmitters. Depending on an implementation, locations of a set of transmitters may, for example, be represented via geographic coordinates (e.g., latitude, longitude, etc.), any suitable reference frame, such as (X, Y, Z) coordinates in three-dimensional Cartesian coordinate space that may be mapped according to a global coordinate system and/or local coordinate system (e.g., an LCI, floor of a venue, etc.), or the like. Optionally or alternatively, locations of a set of transmitters may also include references to a street address, governmental jurisdiction, postal zip code, altitude, time, direction, distance (e.g., from one point of reference to another point of reference, etc.), etc. As discussed above, identities of a set of transmitters may, for example, be represented via unique identifiers, such as MAC address, Cell ID, Bluetooth device ID; NFC device ID, or the like. At times, a wireless transmitter's age may also be stored in a cache of a mobile device, as will also be seen.

As previously indicated, to maintain a cache of parameters, in some instances, a set cover-type approach may, for example, be employed, at least in part. More specifically, as described below, parameters of one or more wireless transmitters sufficient to perform a positioning operation, which may include, for example, transmitters more frequently used for positioning within certain areas (e.g., well-travelled, more frequently visited, etc.) may be identified and saved in a cache of a mobile device using a batch mode and/or a continuous mode. In some instances, such as if a set cover-type approach is implemented in connection with Wi-Fi access points (APs), for example, parameters of a set of transmitters may be organized and/or saved in the form of a so-called “Useful AP List.” A “Useful AP List” may, for example, be used, at least in part, for more efficient positioning even if one or more corresponding tiles are moved or deleted from a cache. Claimed subject matter is not limited to particular types of wireless transmitters, cache organization, etc., of course.

Thus, regarding a set cover-type approach, in certain simulations or experiments, it has been observed that, for a collection of sets (e.g., of wireless transmitters, etc.) drawn from a common universe (e.g., positioning tiles for areas of interest, etc.), it may be useful to find a sub-collection of sets, of minimum size, so that their union includes every item from the universe (e.g., wireless transmitters more frequently used for positioning within such areas, etc.). Namely, in a batch mode, results of a scan discussed above, may, for example, be collected via one or more scan lists over a certain period of time, such as one week, two weeks, one month, etc. A scan list may comprise, for example, a set of wireless transmitters observed within a particular area of interest, just to illustrate one possible implementation. As such, given n scan lists F=(F₁; F₂; . . . ; Fₑ), for m wireless transmitters, such as, for example, Wi-Fi access points (APs) denoted as AP=(AP₁; AP₂; . . . ; APₘ), a binary array M of size n×m may be generated. In the array M, each row may correspond to a scan list, for example, and each column may correspond to an access point. The array M may comprise, for example, binary observation information, such that:

Mᵢⱼ=1 if APⱼ is observed in scan list Fᵢ, otherwise Mᵢⱼ=0.

According to an implementation, to identify more useful access points (e.g., for a “Useful APs List”), the greedy-type algorithm or process, such as making a locally optimal access point selection at each iteration, for example, may be utilized, at least in part. Thus, consider:

Step 1: In M, calculate a sum of every column as

$$S = ( {\sum }_{i = 1}^{n} {M}_{i 1} , {\sum }_{i = 1}^{n} {M}_{i 2} , … , {\sum }_{i = 1}^{n} {M}_{{im}_{t}} )$$

Step 2: Find Sₖ=max(S) and choose APₖ to be a more useful access point.

Step 3: Delete rows in M where M_{ri, k}=1.

Step 4: Delete column k from M.

Step 5: If M is empty, stop; otherwise, proceed to Step 1 and repeat until all appropriate points are covered.

Here, a number of columns, mₜ, in array M may, for example, change in each iteration. As a way of illustration, in the first iteration, mₜ=m, for example, and in the following iterations, mₜ<m.

As such, a batch mode may, for example, return a set of more useful access points, such as represented via indices k=[k₁; . . . ; kₚ], such that a sub-array M(:, k) may not have any zero rows, meaning that every scan list in a scanning history may include at least one useful access point from the set. Accordingly, with this set of access points, all or most considered scan lists may, for example, be located, if needed or desired, such as to be used, at least in part, for positioning.

Since a batch mode may involve collecting and/or saving a number of scan lists over some period of time, in some instances, a size of the array M may, for example, increase significantly so as to make parameter processing more difficult or, at times, prohibitively expensive. In such a case, a continuous mode may, for example, be used, at least in part, or otherwise considered, as was indicated. More specifically, in a continuous mode, collected scan lists may, for example, be processed continually (e.g., via a server, mobile device, etc.), such as while new scan lists are being collected. Here, to build or generate a “Useful AP List,” the following process may, for example, be employed or otherwise considered:

Step 1: Obtain access point importance metric for all access points in a scan list. For example, if one or more access points in a scan list are already marked as “useful,” such a metric may be used, at least in part, to include these access points into a “Useful AP List.” One or more access points may, for example, be marked as “useful” if these access points have been observed a certain number of times within some pre-defined time period (e.g., observed ten times within one hour, fifty times within one day, etc.). In some instances, an age of an access point may also be used, at least in part, or otherwise considered in determining importance of the access point. Access point's age may, for example, be defined via or quantized into a number of days, just to illustrate one possible implementation. For example, in certain simulations or experiments, it has been observed that older access points may be less important, such as for purposes of access points' ranking, etc. Particular examples of access point's age and ranking will be discussed in greater detail below.

Step 2: If, however, no access points are marked as “useful,” to facilitate or support locating a scan list, select one or more appropriate access points and designate these as “useful.” For example, in some instances, a number of access points observed or detected within a certain time period (e.g., one hour, four hours, twelve hours, one day, week, etc.) may be determined, and one or more access points with a higher number of observations or detections may be marked as “useful.”

Step 3: Continue to the next scan list, and repeat from Step 1, if applicable.

In some instances, here, a sliding time window (e.g., every month, etc.) may, for example, be implemented, meaning that whenever a new scan list is obtained, a mobile device, server, etc. may verify whether any of wireless transmitters in the scan list are useful (e.g., used more frequently in relation to other transmitters, etc.) during that particular time window. This may facilitate or support generating and/or updating a “Useful AP List” in a timely fashion, such as via including more useful access points from a previous month, for example.

At times, a scan list may comprise, for example, one or more transmitters locations of which may be unknown to a server and/or mobile device (e.g., not in a wireless transmitter database, cache, memory, etc.). For example, a particular area of interest may include a newly-installed wireless transmitter, a transmitter that has been recently relocated, replaced, put in service, or the like. In some instances, an unknown location of a wireless transmitter may, for example, be estimated or approximated using locations of one or more known neighboring transmitters, such as by averaging their locations, for example, though claimed subject matter is not so limited. Other suitable location estimation techniques may also be used, in whole or in part, or otherwise considered.

As was also indicated, in some instances, to maintain a cache of parameters, a wireless transmitter ranking-type approach may, for example, be employed, at least in part. At times, this approach may, for example, be implemented via two aspects: a wireless transmitter discovery aspect and a wireless transmitter ranking aspect, just to illustrate one possible implementation. A wireless transmitter discovery aspect may, for example, be used, at least in part, to identify and/or collect information with respect to wireless transmitters within and/or proximate to an area of interest. A wireless transmitter ranking aspect may, for example, be used, at least in part, to determine which wireless transmitters may be kept in a cache (e.g., as more useful transmitters, etc.) and/or which transmitters may be deleted or moved, such as if storage capacity limits are reached, for example.

Thus, regarding a wireless transmitter discovery aspect, a list of wireless transmitters detected or observed by a mobile device (e.g., via a scan, etc.) within a certain time period (e.g., in the past 24 hours, etc.) may, for example, be stored in a memory cache of the mobile device. In some instances, such as if a wireless transmitter discovery aspect is implemented in connection with Wi-Fi access points (APs), for example, detected or observed transmitters may be organized and/or stored in the form of a so-called “Freshly Detected AP List” or FDAPL. As a way of illustration, one particular example of an FDAPL is shown in Table 1 below. Claimed subject matter is not so limited, of course.

TABLE 1
Example of a FDAPL (e.g., 9.0 bytes).

| | | |
|---|---|---|
| MAC | Counter of how many | . . . |
| (8 bytes) | times an AP has been | |
| | detected during past | |
| | 24 hours | |
| | (1 byte) | |

Here, a counter (e.g., how many times a particular AP has been detected during past 24 hours, etc.) may, for example, be quantized or qualified by duration (e.g., via 10-minute time periods, etc.), meaning that during a certain period of time (e.g., every 10 minutes, etc.), no matter how many times an access point has been seen or observed, a counter for that access point may only increase by 1.0. This may, for example, facilitate or support weighting contributions of frequently observed access points during ranking more evenly. Access points on an FDAPL and/or cache may, for example, be evaluated in some manner (e.g., every 24 hours, etc.) with respect to their usefulness, such as via a wireless transmitter ranking aspect, discussed below. In certain simulations or experiments, an FDAPL comprising parameters of 10,000 access points, (e.g., ˜90.0 Kbytes) was used, though claimed subject matter is not so limited. If storage capacity permits, newly-detected access points may, for example, be added to a cache of a mobile device; otherwise, it may be needed or useful to delete or move one or more access points from a cache, as was indicated. At times, here, a so-called “first in-first out” concept or approach may, for example, be employed, but may prove less beneficial, such as if newly-detected access points are used more frequently, for example. Again, claimed subject matter is not limited to a particular type of a wireless transmitter, cache organization, or the like.

Continuing with the above example, in some instances, wireless transmitters may, for example, be evaluated via a wireless transmitter ranking aspect, as was indicated. Thus, at times, a mobile device's cache may, for example, be maintained via replacing one or more lower-ranking wireless transmitters with one or more transmitters having a higher ranking score. Likewise, here, even though a description below references Wi-Fi access points, any other suitable types of wireless transmitters (e.g., cellular base stations, etc.) may be used, in whole or in part. As alluded to previously, here, to evaluate access points with respect to their usefulness, access point's age as well as a number of access point observations may, for example, be used, at least in part, or otherwise considered. Access point's age may, for example, be defined as:

AP's Age=if in an FDAPL, then 0,

if not in an FDAL, then increase by 1 from a previous age value.

At times, access point's age may, for example, be quantized into or qualified by a certain number of days, such as in a fashion similar to duration discussed above (e.g., increase access point's age by 1 only if the access point is not listed in an FDAPL during a certain number of days, etc.).

According to an implementation, a usefulness of an access point may, for example, be defined or characterized via the following:

(1) The more often a particular access point is observed within an area, the more useful it may be for that area.

(2) The higher an age-related value of a particular access point for an area, the less important this access point may be for that area.

At times, a usefulness of an access point may, for example, be determined via computing its usefulness score, such as according to the following formulation:

AP Usefulness Score=freqRatio×numSeen−ageRatio×Age

Here, freqRatio denotes the weight ratio or weight number for a frequency with which an access point has been “heard” or observed by a mobile device within some time period, and ageRatio denotes the weight ratio or weight number for “freshness” of an access point (e.g., a time elapsed since access point's last observation); both freqRatio and ageRatio may comprise positive numbers. These ratios may be determined, at least in part, experimentally and may be pre-defined, for example, or otherwise dynamically defined in some manner depending on a particular wireless environment, access point, tile, application, or the like. numSeen denotes a number of times an access point has been observed. Also, at times, numSeen and/or Age of an access point may, for example, be capped so as to limit or reduce their influence on the AP Usefulness Score. For example, in some instances, a user of a mobile device may relocate (e.g., move to another geographic area, etc.), but a cache on a user's mobile device may still have a list of access points ranked based, at least in part, on their previous (e.g., now less relevant, outdated, etc.) usefulness. At times, lowering or getting rid of some higher-ranked, but less useful access points from a cache, such as via an AP Usefulness Score, for example, may be time-consuming. In other words, less useful, but higher-ranked access points on a list may be lowered or replaced gradually and, as such, may stay in a cache for a relatively long time. Thus, to address this issue, in some instances, cached parameters for one or more access points that have been inactive, such as not observed within a certain time period (e.g., 30, 60, 90, etc. days), for example, may be removed or deleted from a cache. This may facilitate or support more dynamic cache management, for example.

Thus, in operative use, to maintain a cache of parameters, such as if storage capacity limits are reached, for example, an AP Usefulness Score for a newly-detected or observed access point may be compared against an AP Usefulness Score for one or more access points. As was indicated, parameters for one or more lower ranking access points may, for example, be removed from a cache, and, at times, may be replaced with parameters for one or more higher ranking access points. If an access point is marked “relocated” (e.g., by an access point's owner, service company, server, mobile device, etc.), its numSeen value may be reset to a current day's count. Also, at times, it may be more useful or desirable to utilize fixed or stationary wireless transmitters (e.g., Wi-Fi access points, etc.) rather than transmitters whose locations may change from time to time, such as mobile wireless transmitters or devices, for example. Here, mobile wireless transmitters may, for example, be blacklisted via an appropriate mechanism or approach (e.g., via a blacklist, etc.) that may be locally stored on a mobile device.

Having determined that a particular access point is more useful so as to be stored in a cache, a mobile device may communicate with a suitable server (e.g., a location server, positioning assistance server, etc.) to request one or more additional parameters for such an access point. By way of example, one or more parameters descriptive of attributes of a set of transmitters may include these represented in Table 2 below. Thus, consider:

TABLE 2
Example parameters (e.g., 24 Bytes).

| | | | | | |
|---|---|---|---|---|---|
| MAC | LLA | CAR/MAR | numSeen | Age | . . . |
| address | (4 + 4 + 2 byte) | (2 byte) | (2 byte) | (1 byte) | |
| (8 byte) | | | | | |

Here, LLA denotes Latitude, Longitude, Altitude, and CAR/MAR denotes Calculated Antenna Range/Maximum Antenna Range, which may be used, at least in part, to calculate a mobile device's position uncertainty, such as via one or more appropriate techniques. Parameters descriptive of attributes of a set of transmitters may be subsequently used, at least in part, such as, for example, to determine whether it may be useful to download a tile, as discussed below.

Thus, referring back to example process 200 of FIG. 2, at operation 204, a mobile device may, for example, attempt to match an acquired wireless signal with the identities of the set of transmitters sufficient to perform the positioning operation. As was indicated, identities of a set of transmitters may, for example, be encoded in an acquired wireless signal, such as in the form of unique identifiers, such as a MAC address, a Cell ID, Bluetooth device ID, NFC device ID, etc., or any combination thereof. Thus, here, using a Wi-Fi access point as an example, a mobile device may attempt to match a unique identifier, such as a MAC address of a visible or proximate access point on an FDAPL, for example, with a MAC address of one or more access points in a cache, just to illustrate one possible implementation. In an attempt to match these parameters, a mobile device may, for example, access a cache and/or locally stored database of previously downloaded tiles, if available, such as prior to accessing a server and/or downloading a tile. If a MAC address of a visible or proximate access point matches with at least one MAC address of a set of transmitters, for example, a mobile device may determine that it may be capable of obtaining a position fix autonomously, such as without accessing a remote server and/or downloading a positioning tile. As such, a mobile device may, for example, be capable of autonomously locating itself, such as using any suitable positioning techniques (e.g., base station identification, cell tower triangulation, radio heat map signature matching, proximity, AFLT, etc.). If a parameter matching attempt fails, however, a mobile device may, for example, selectively download a tile, as discussed below.

For example, at operation 206, a mobile device may selectively download a tile of positioning assistance parameters descriptive of attributes of one or more additional transmitters based, at least in part, on an absence of a match of the acquired wireless signal with the identities of the set of transmitters sufficient to perform the positioning operation. Again, to illustrate using the above example, if an acquired MAC address (e.g., in an FDAPL, etc.) does not match a MAC address of at least one known access point stored in a cache and/or local tile database, if available, a mobile device may, for example, determine that it may not be capable of obtaining a position fix autonomously and, thus, may access a server so as to download an additional tile of positioning assistance parameters, as was indicated.

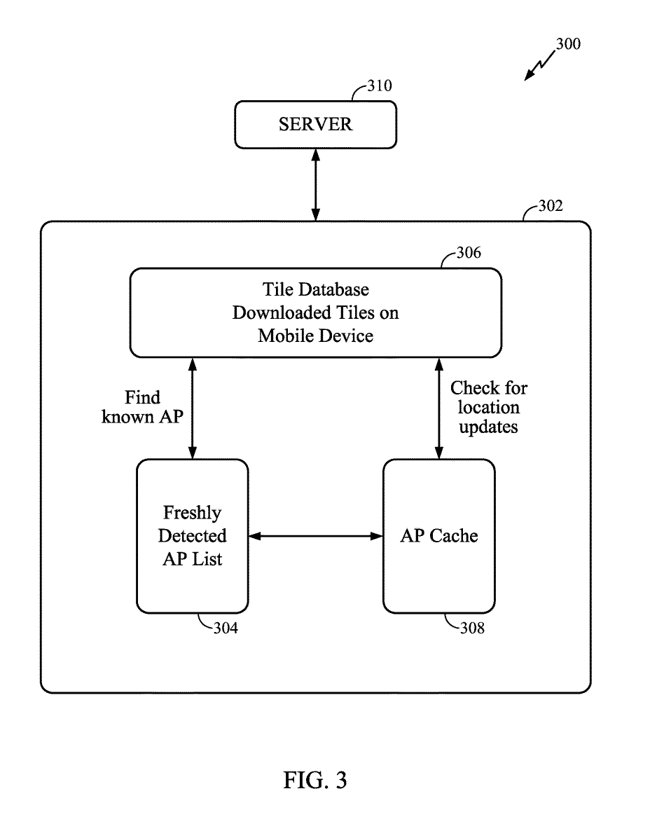

FIG. 3 is a flow diagram of an implementation of a process 300 illustrating an example use case or scenario for selective downloading of one or more positioning tiles using a cache of transmitter parameters for use in or with a mobile device 302. Here, mobile device 302 may, for example, include one or more features or aspects of mobile device 102 of FIG. 1, though claimed subject matter is not so limited. As was indicated, mobile device 302 may, for example, perform one or more scans (e.g., an active scan, passive scan, etc.) to acquire signals transmitted by proximate or “visible” wireless transmitters and/or detect parameters encoded in the acquired signals (e.g., unique identifiers, etc.). As was indicated, at times, parameters of one or more observed wireless transmitters may, for example, be stored in a “Freshly Detected AP List” or FDAPL 304. FDAPL 304 may, for example, be compiled and/or updated in a suitable manner, such as in connection with maintaining an access point (AP) cache 308, for example, via selecting, ranking, and/or replacing parameters of more useful access points, as discussed above.

As also illustrated, in some instances, mobile device 302 may include, for example, a database of previously downloaded positioning tiles, referenced at 306. Tile database 306 may comprise, for example, one or more positioning tiles previously downloaded by mobile device 302 for particular areas of interest. Even though tile database 306 is illustrated as a separate unit or feature, it should be noted that all or part of tile database 306 may, for example, be included in AP cache 308. It should also be noted that tile database 306 may be optional in certain example implementations. Thus, mobile device 302 may, for example, attempt to match parameters of one or more observed wireless transmitters stored in FDAPL 304 with identities of known transmitters, such as via accessing AP cache 308 and/or tile database 306, if applicable. In at least one implementation, mobile device 302 may, for example, first compare parameters stored in FDAPL 304 with parameters in AP cache 308 to find a match. If no match of parameters in AP cache 308 is found, mobile device 302 may, for example, access tile database 306 in an attempt to locate and/or match parameters, such as prior to contacting or accessing a server 310. At times, if a number of transmitters stored in AP cache 308 is not sufficient to perform a particular positioning operation (e.g., three for trilateration, etc.), and/or a ratio of detected access points is below a certain threshold (e.g., less than 25%, etc.), mobile device 302 may access tile database 306 rather than AP cache 308. In at least one implementation, a ratio of detected access points may be defined as or represented via a number of detected transmitters divided by a number of transmitters stored in FDAPL 304. Claimed subject matter is not so limited, of course.

In some instances, if there is a sufficient match with parameters stored in AP cache 308 to enable a successful positioning operation, mobile device 302 may refrain from accessing tile database 306 and/or server 310 so as to download any additional tiles. If no sufficient match to enable a successful positioning operation is found (e.g., in AP cache 308 and/or tile database 306, if available), mobile device 302 may then forward acquired parameters (e.g., unique identifiers, etc.) to server 310 to download an additional tile, as discussed above. One or more additional tiles may, for example, be downloaded to tile database 306, though claimed subject matter is not so limited. For example, one or more tiles may be downloaded to a main memory and corresponding parameters may be subsequently moved and/or stored in AP cache 308, such as after usefulness-type evaluation, as discussed above. As also illustrated, at times, AP cache 308 may, for example, communicate with tile database 306 and/or server 310 (e.g., every 12, 24, etc. hours, etc.) so as to check for updates with respect to parameters of a set of transmitters, which may include those illustrated in Table 2 above.

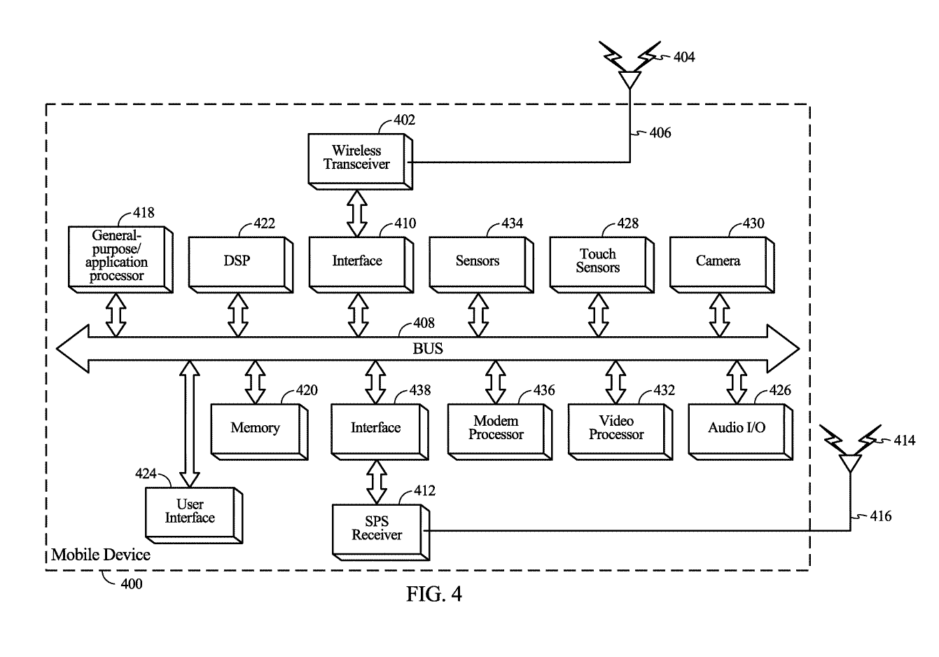

FIG. 4 is a schematic diagram of an implementation of an example computing environment associated with a mobile device that may be used, at least in part, to facilitate or support one or more operations or techniques for selective downloading of one or more positioning tiles using a cache of transmitter parameters. An example computing environment may comprise, for example, a mobile device 400 that may include one or more features or aspects of mobile device 102 of FIG. 1, mobile device 302 of FIG. 3, though claimed subject matter is not so limited. For example, in some instances, mobile device 400 may comprise a wireless transceiver 402 capable of transmitting or receiving wireless signals, referenced generally at 404, such as via an antenna 406 over a suitable wireless communications network. Wireless transceiver 402 may, for example, be capable of sending or receiving one or more suitable communications, such as one or more communications discussed with reference to FIGS. 1-3. Wireless transceiver 402 may, for example, be coupled or connected to a bus 408 via a wireless transceiver bus interface 410. Depending on an implementation, at times, wireless transceiver bus interface 410 may, for example, be at least partially integrated with wireless transceiver 402. Some implementations may include multiple wireless transceivers 402 or antennas 406 so as to enable transmitting or receiving signals according to a corresponding multiple wireless communication standards such as Wireless Fidelity (WiFi), Code Division Multiple Access (CDMA), Wideband-CDMA (W-CDMA), Long Term Evolution (LTE), Bluetooth®, just to name a few examples.

In an implementation, mobile device 400 may, for example, comprise an SPS or like receiver 412 capable of receiving or acquiring one or more SPS or other suitable wireless signals 414, such as via an SPS or like antenna 416. SPS receiver 412 may process, in whole or in part, one or more acquired SPS signals 414 for estimating a location of mobile device 400. In some instances, one or more general-purpose application processors 418 (henceforth referred to as “processor”), memory 420, digital signal processor(s) (DSP) 422, or like specialized devices or processors not shown may be utilized to process acquired SPS signals 414, in whole or in part, calculate a location of mobile device 400, such as in conjunction with SPS receiver 412, or the like. Storage of SPS or other signals for implementing one or more positioning operations, such as in connection with one or more techniques for selective downloading of one or more positioning tiles using a cache of transmitter parameters, for example, may be performed, at least in part, in memory 420, suitable registers or buffers (not shown). Although not shown, it should be appreciated that in at least one implementation one or more processors 418, memory 420, DSPs 422, or like specialized devices or processors may comprise one or more processing modules capable of maintaining a cache of parameters descriptive of attributes of a set of transmitters, the attributes indicating at least locations and identities of the set of transmitters; attempting to match an acquired wireless signal with the identities of the set of transmitters sufficient to perform the positioning operation; and selectively downloading a tile of positioning assistance parameters descriptive of attributes of one or more additional transmitters based, at least in part, on an absence of a match of the acquired wireless signal with the identities of the set of transmitters sufficient to perform the positioning operation.

It should be noted that all or part of one or more processing modules may be implemented using or otherwise including hardware, firmware, software, or any combination thereof. Processing modules may be representative of one or more circuits capable of performing at least a portion of information computing technique or process. By way of example but not limitation, processor 418 or DSP 422 may include one or more processors, controllers, microprocessors, microcontrollers, application specific integrated circuits, digital signal processors, programmable logic devices, field programmable gate arrays, or the like, or any combination thereof. Thus, at times, processor 418 or DSP 322 or any combination thereof may comprise or be representative of means for maintaining a cache of parameters descriptive of attributes of a set of transmitters, the attributes indicating at least locations and identities of the set of transmitters, such as to implement operation 202 of FIG. 2, at least in part. In addition, in at least one implementation, processor 418 or DSP 322 may be representative of or comprise, for example, means for attempting to match an acquired wireless signal with the identities of the set of transmitters sufficient to perform the positioning operation, such as to implement operation 204 of FIG. 2, at least in part. Also, at times, processor 418 or DSP 322 may comprise, for example, or be representative of means for selectively downloading a tile of positioning assistance parameters descriptive of attributes of one or more additional transmitters based, at least in part, on an absence of a match of the acquired wireless signal with the identities of the set of transmitters sufficient to perform the positioning operation, as illustrated in or described with respect to operation 206 of FIG. 2, for example.

As illustrated, DSP 422 may be coupled or connected to processor 418 and memory 420 via bus 408. Although not shown, in some instances, bus 408 may comprise one or more bus interfaces that may be integrated with one or more applicable components of mobile device 400, such as DSP 422, processor 418, memory 420, or the like. In various embodiments, one or more operations or functions described herein may be performed in response to execution of one or more machine-readable instructions stored in memory 420, such as on a computer-readable storage medium, such as RAM, ROM, FLASH, disc drive, etc., just to name a few examples. Instructions may, for example, be executable via processor 418, one or more specialized processors not shown, DSP 422, or the like. Memory 420 may comprise a non-transitory processor-readable memory, computer-readable memory, etc. that may store software code (e.g., programming code, instructions, etc.) that may be executable by processor 418, DSP 422, or the like to perform operations or functions described herein.

Mobile device 400 may comprise a user interface 424, which may include any one of several devices such as, for example, a speaker, microphone, display device, vibration device, keyboard, touch screen, etc., just to name a few examples. In at least one implementation, user interface 424 may enable a user to interact with one or more applications hosted on mobile device 400. For example, one or more devices of user interface 424 may store analog or digital signals on memory 420 to be further processed by DSP 422, processor 418, etc. in response to input or action from a user. Similarly, one or more applications hosted on mobile device 400 may store analog or digital signals in memory 420 to present an output signal to a user. In some implementations, mobile device 400 may optionally include a dedicated audio input/output (I/O) device 426 comprising, for example, a dedicated speaker, microphone, digital to analog circuitry, analog to digital circuitry, amplifiers, gain control, or the like. It should be understood, however, that this is merely an example of how audio I/O device 426 may be implemented, and that claimed subject matter is not limited in this respect. As seen, mobile device 400 may comprise one or more touch sensors 428 responsive to touching or like pressure applied on a keyboard, touch screen, or the like.

In an implementation, mobile device 400 may comprise, for example, a camera 440, dedicated or otherwise, such as for capturing still or moving imagery, or the like. Camera 440 may comprise, for example, a camera sensor or like imaging device (e.g., charge coupled device, complementary metal oxide semiconductor (CMOS)-type imager, etc.), lens, analog to digital circuitry, frame buffers, etc., just to name a few examples. In some instances, additional processing, conditioning, encoding, or compression of signals representing one or more captured images may, for example, be performed, at least in part, at processor 418, DSP 422, or the like. Optionally or alternatively, a video processor 432, dedicated or otherwise, may perform conditioning, encoding, compression, or manipulation of signals representing one or more captured images. Additionally, video processor 432 may, for example, decode or decompress one or more stored images for presentation on a display (not shown) of mobile device 400.

Mobile device 400 may comprise one or more sensors 434 coupled or connected to bus 408, such as, for example, one or more inertial sensors, ambient environment sensors, or the like. Inertial sensors of sensors 434 may comprise, for example, one or more accelerometers (e.g., collectively responding to acceleration of mobile device 400 in one, two, or three dimensions, etc.), gyroscopes or magnetometers (e.g., to support one or more compass or like applications, etc.), etc., just to illustrate a few examples. Ambient environment sensors of mobile device 400 may comprise, for example, one or more barometric pressure sensors, temperature sensors, ambient light detectors, camera sensors, microphones, etc., just to name few examples. Sensors 434 may generate analog or digital signals that may be stored in memory 420 and may be processed by DSP 422, processor 418, etc., such as in support of one or more applications directed to positioning or navigation operations, wireless communications, radio heat map learning, video gaming or the like.

In a particular implementation, mobile device 400 may comprise, for example, a modem processor 436, dedicated or otherwise, capable of performing baseband processing of signals received or downconverted via wireless transceiver 402, SPS receiver 412, or the like. Similarly, modem processor 436 may perform baseband processing of signals to be upconverted for transmission via wireless transceiver 402, for example. In alternative implementations, instead of having a dedicated modem processor, baseband processing may be performed, at least in part, by processor 418, DSP 422, or the like. In addition, in some instances, an interface 438, although illustrated as a separate component, may be integrated, in whole or in part, with one or more applicable components of mobile device 400, such as bus 408 or SPS receiver 412, for example. Optionally or alternatively, SPS receiver 412 may be coupled or connected to bus 408 directly. It should be understood, however, that these are merely examples of components or structures that may perform baseband processing, and that claimed subject matter is not limited in this regard.

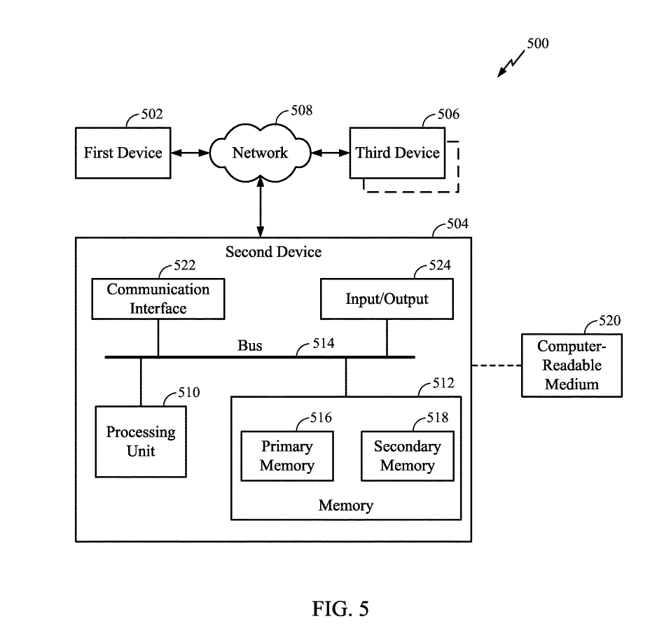

FIG. 5 is a schematic diagram illustrating an implementation of an example computing environment or system 500 that may be associated with or include one or more servers or other devices capable of partially or substantially implementing or supporting one or more operations or techniques for selective downloading of one or more positioning tiles using a cache of transmitter parameters, such as discussed above in connection with FIGS. 1-3, for example. Computing environment 500 may include, for example, a first device 502, a second device 504, a third device 506, etc., which may be operatively coupled together via a communications network 508. In some instances, first device 502 may comprise a server capable of providing positioning assistance parameters, such as, for example, identities, locations, etc. of known wireless transmitters, radio heat map, base station almanac, electronic digital map, database of wireless transmitters, positioning tiles, or the like. For example, first device 502 may also comprise a server capable of providing an electronic digital map to a mobile device based, at least in part, on a coarse or rough estimate of a location of the mobile device, upon request, or the like. First device 502 may also comprise a server capable of providing any other suitable positioning assistance parameters (e.g., an electronic digital map, radio heat map, etc.), relevant to a location of a mobile device. Second device 504 or third device 506 may comprise, for example, mobile devices, though claimed subject matter is not so limited. For example, in some instances, second device 504 may comprise a server functionally or structurally similar to first device 502, just to illustrate another possible implementation. In addition, communications network 508 may comprise, for example, one or more wireless transmitters, such as access points, femtocells, or the like. Of course, claimed subject matter is not limited in scope in these respects.

First device 502, second device 504, or third device 506 may be representative of any device, appliance, platform, or machine that may be capable of exchanging parameters and/or information over communications network 508. By way of example but not limitation, any of first device 502, second device 504, or third device 506 may include: one or more computing devices or platforms, such as, for example, a desktop computer, a laptop computer, a workstation, a server device, or the like; one or more personal computing or communication devices or appliances, such as, for example, a personal digital assistant, mobile communication device, or the like; a computing system or associated service provider capability, such as, for example, a database or information storage service provider/system, a network service provider/system, an Internet or intranet service provider/system, a portal or search engine service provider/system, a wireless communication service provider/system; or any combination thereof. Any of first, second, or third devices 502, 504, and 506, respectively, may comprise one or more of a mobile device, wireless transmitter or receiver, server, etc. in accordance with example implementations described herein.

In an implementation, communications network 508 may be representative of one or more communication links, processes, or resources capable of supporting an exchange of information between at least two of first device 502, second device 504, or third device 506. By way of example but not limitation, communications network 508 may include wireless or wired communication links, telephone or telecommunications systems, information buses or channels, optical fibers, terrestrial or space vehicle resources, local area networks, wide area networks, intranets, the Internet, routers or switches, and the like, or any combination thereof. As illustrated, for example, via a dashed lined box partially obscured by third device 506, there may be additional like devices operatively coupled to communications network 508. It is also recognized that all or part of various devices or networks shown in computing environment 500, or processes or methods, as described herein, may be implemented using or otherwise including hardware, firmware, software, or any combination thereof.

By way of example but not limitation, second device 504 may include at least one processing unit 510 that may be operatively coupled to a memory 512 via a bus 514. Processing unit 510 may be representative of one or more circuits capable of performing at least a portion of a suitable computing procedure or process. For example, processing unit 510 may include one or more processors, controllers, microprocessors, microcontrollers, application specific integrated circuits, digital signal processors, programmable logic devices, field programmable gate arrays, or the like, or any combination thereof. Although not shown, second device 504 may include a location-tracking unit that may initiate a position fix of a suitable mobile device, such as in an area of interest, for example, based, at least in part, on one or more received or acquired wireless signals, such as from an SPS, one or more Wi-Fi access points, etc. In some implementations, a location-tracking unit may be at least partially integrated with a suitable processing unit, such as processing unit 510, for example, though claimed subject matter is not so limited. In certain server-based or server-supported implementations, processing unit 510 may, for example, comprise means for maintaining, at a server device, a cache of parameters descriptive of attributes of a set of transmitters for an area, the attributes indicating at least locations and identities of the set of transmitters, such as to facilitate or support operations 202, 204, and/or 206 of FIG. 2, at least in part. In some instances, processing unit 510 may, for example, comprise means for attempting, in response to a message from a mobile device, to match the identities of the set of transmitters sufficient to perform the positioning operation with parameters descriptive of attributes of one or more additional transmitters within the area received via the message, such as to facilitate or support operations 202, 204, and/or 206 of FIG. 2, at least in part. Depending on an implementation, processing unit 510 may also comprise, for example, means for estimating a location of the mobile device based, at least in part, on a match of the identities of the set of transmitters sufficient to perform the positioning operation with the parameters descriptive of the attributes of the one or more additional transmitters within the area, such as to facilitate or support operations 202, 204, and/or 206 of FIG. 2, at least in part.

Memory 512 may be representative of any information storage mechanism or appliance. Memory 512 may include, for example, a primary memory 516 and a secondary memory 518. Primary memory 516 may include, for example, a random access memory, read only memory, etc. While illustrated in this example as being separate from processing unit 510, it should be understood that all or part of primary memory 516 may be provided within or otherwise co-located/coupled with processing unit 510. Secondary memory 518 may include, for example, same or similar type of memory as primary memory or one or more information storage devices or systems, such as, for example, a disk drive, an optical disc drive, a tape drive, a solid state memory drive, etc. In certain implementations, secondary memory 518 may be operatively receptive of, or otherwise configurable to couple to, a computer-readable medium 520. Computer-readable medium 520 may include, for example, any non-transitory storage medium that may carry or make accessible information, code, or instructions for one or more of devices in computing environment 500. Computer-readable medium 520 may also be referred to as a machine-readable medium, storage medium, or the like.

Second device 504 may include, for example, a communication interface 522 that may provide for or otherwise support an operative coupling of second device 504 to at least communications network 508. By way of example but not limitation, communication interface 522 may include a network interface device or card, a modem, a router, a switch, a transceiver, and the like. Second device 504 may also include, for example, an input/output device 524. Input/output device 524 may be representative of one or more devices or features that may be configurable to accept or otherwise introduce human or machine inputs, or one or more devices or features that may be capable of delivering or otherwise providing for human or machine outputs. By way of example but not limitation, input/output device 524 may include an operatively configured display, speaker, keyboard, mouse, trackball, touch screen, information port, or the like.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (DSPs), digital signal processing devices (“DSPDs”), programmable logic devices (“PLDs”), field programmable gate arrays (“FPGAs”), processors, controllers, micro-controllers, microprocessors, electronic devices, other devices units de-signed to perform the functions described herein, or combinations thereof.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, messages, parameters, frames, packets, content and/or the like. It should be understood, however, that all of these and/or similar terms are to be associated with appropriate physical quantities or manifestations, and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. Likewise, operation of a memory device to store bits, values, elements, symbols, characters, terms, numbers, numerals, measurements, messages, parameters, frames, packets, content and/or the like may comprise a physical transformation. With particular types of memory devices, such a physical transformation may comprise a physical transformation of an article to a different state or thing. For example, but without limitation, for some types of memory devices, a change in state may involve an accumulation and/or storage of charge or a re-lease of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) net-work, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. Signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

1. A method for performing a positioning operation, comprising:
maintaining, at a mobile device, a cache of parameters descriptive of attributes of a set of transmitters, said attributes indicating at least locations and identities of said set of transmitters;
attempting to match an acquired wireless signal with said identities of said set of transmitters sufficient to perform said positioning operation; and
selectively downloading a tile of positioning assistance parameters descriptive of attributes of one or more additional transmitters based, at least in part, on an absence of a match of said acquired wireless signal with said identities of said set of transmitters sufficient to perform said positioning operation.

2. The method of claim 1, and further comprising:
replacing at least one of said parameters descriptive of said attributes of said set of transmitters with at least one of said parameters descriptive of said attributes of said one or more additional transmitters.

3. The method of claim 2, wherein said replacing said at least one of said parameters further comprises:
identifying parameters descriptive of at least one of said attributes of said one or more additional transmitters matching said acquired signals; and
replacing in said cache parameters descriptive of at least one of said attributes of said set of transmitters with said identified parameters.

4. The method of claim 3, wherein said replacing in said cache said parameters descriptive of said at least one of said attributes of said set of transmitters matching said acquired signals further comprises:
ranking said identified parameters relative to said parameters descriptive of said attributes of said set of transmitters; and
removing lowest ranking parameters from said cache.

5. The method of claim 1, wherein said wireless signal is acquired via a scan.

6. The method of claim 1, wherein said maintaining said cache is based, at least in part, on at least one of the following: a set cover-type approach; a wireless transmitter ranking-type approach; or any combination thereof.

7. The method of claim 1, wherein said acquired wireless signal is encoded with one or more unique identifiers of said one or more additional transmitters.

8. The method of claim 7, wherein said selectively downloading said tile of said positioning assistance parameters is based, at least in part, on transmitting at least one of said one or more unique identifiers to a server.

9. The method of claim 7, wherein said one or more unique identifiers comprise at least one of the following: a MAC address; a Cell ID; a Bluetooth device ID; an NFC device ID; or any combination thereof.

10. The method of claim 1, wherein said set of transmitters and said additional transmitters comprise at least one of the following: Wi-Fi access points; cellular base stations; Bluetooth devices; NFC devices; or any combination thereof.

11. The method of claim 1, wherein said attempting to match said acquired wireless signal with said identities of said set of transmitters sufficient to perform said positioning operation further comprises accessing a tile database stored on said mobile device.

12. An apparatus to perform a positioning operation comprising:
means for maintaining, at a mobile device, a cache of parameters descriptive of attributes of set of transmitters, said attributes indicating at least locations and identities of said set of transmitters;
means for attempting to match an acquired wireless signal with said identities of said set of transmitters sufficient to perform said positioning operation; and
means for selectively downloading a tile of positioning assistance parameters descriptive of attributes of one or more additional transmitters based, at least in part, on an absence of a match of said acquired wireless signal with said identities of said set of transmitters sufficient to perform said positioning operation.

13. The apparatus of claim 12, and further comprising:
means for replacing at least one of said parameters descriptive of said attributes of said set of transmitters with at least one of said parameters descriptive of said attributes of said one or more additional transmitters.

14. The apparatus of claim 13, wherein said means for replacing said at least one of said parameters further comprises:
means for identifying parameters descriptive of at least one of said attributes of said one or more additional transmitters matching said acquired signals; and
means for replacing in said cache parameters descriptive of at least one of said attributes of said set of transmitters with said identified parameters.

15. The apparatus of claim 14, wherein said means for replacing in said cache said parameters descriptive of said at least one of said attributes of said set of transmitters matching said acquired signals further comprises:
means for ranking said identified parameters relative to said parameters descriptive of said attributes of said set of transmitters; and
means for removing lowest ranking parameters from said cache.

16. The apparatus of claim 12, wherein said means for maintaining said cache comprise means to implement at least one of the following: a set cover-type approach; a wireless transmitter ranking-type approach; or any combination thereof.

17. The apparatus of claim 12, wherein said acquired wireless signal is encoded with one or more unique identifiers of said one or more additional transmitters.

18. The apparatus of claim 17, wherein said means for selectively downloading said tile of said positioning assistance parameters further comprise means for transmitting at least one of said one or more unique identifiers to a server.

19. An apparatus to perform a positioning operation comprising:
a mobile device comprising:
a wireless transceiver to communicate with an electronic communications network; and
one or more processors coupled to a memory to:
maintain a cache of parameters descriptive of attributes of set of transmitters, said attributes to indicate at least locations and identities of said set of transmitters;
attempt to match an acquired wireless signal with said identities of said set of transmitters sufficient to perform said positioning operation; and
selectively download, via said electronic communications network, a tile of positioning assistance parameters descriptive of attributes of one or more additional transmitters based, at least in part, on an absence of a match of said acquired wireless signal with said identities of said set of transmitters sufficient to perform said positioning operation.

20. The apparatus of claim 19, wherein said one or more processors further to:
replace at least one of said parameters descriptive of said attributes of said set of transmitters with at least one of said parameters descriptive of said attributes of said one or more additional transmitters.

21. The apparatus of claim 20, wherein said one or more processors to said replace said at least one of said parameters further to:
identify parameters descriptive of at least one of said attributes of said one or more additional transmitters matching said acquired signals; and
replace in said cache parameters descriptive of at least one of said attributes of said set of transmitters with said identified parameters.

22. The apparatus of claim 21, wherein said one or more processors to said replace in said cache said parameters descriptive of said at least one of said attributes of said set of transmitters matching said acquired signals further to:
rank said identified parameters relative to said parameters descriptive of said attributes of said set of transmitters; and
remove lowest ranking parameters from said cache.

23. The apparatus of claim 19, wherein said one or more processors further to maintain said cache based, at least in part, on at least one of the following: a set cover-type approach; a wireless transmitter ranking-type approach; or any combination thereof.

24. The apparatus of claim 19, wherein said acquired wireless signal is encoded with one or more unique identifiers of said one or more additional transmitters.

25. The apparatus of claim 24, wherein said one or more processors further to selectively download said tile of said positioning assistance parameters based, at least in part, on a transmission of at least one of said one or more unique identifiers to a server.

26. A method for performing a positioning operation comprising:
maintaining, at a server device, a cache of parameters descriptive of attributes of set of transmitters for an area, said attributes indicating at least locations and identities of said set of transmitters;
attempting, in response to a message from a mobile device, to match said identities of said set of transmitters sufficient to perform said positioning operation with parameters descriptive of attributes of one or more additional transmitters within said area received via said message; and
estimating a location of said mobile device based, at least in part, on a match of said identities of said set of transmitters sufficient to perform said positioning operation with said parameters descriptive of said attributes of said one or more additional transmitters within said area.

27. The method of claim 26, and further comprising communicating said estimated location to said mobile device.

28. The method of claim 26, wherein said parameters descriptive of said attributes of said set of transmitters for said area are obtained from said mobile device.

29. The method of claim 26, and further comprising providing a tile of positioning assistance parameters for said area for use by said mobile device.

30. The method of claim 26, wherein said tile is provided if said parameters descriptive of said attributes of said one or more additional transmitters within said area do not sufficiently match parameters in said cache for performing said positioning operation.
